(19) United States
(12) Patent Application Publication
(10) Pub. No.: US 2017/0068110 A1
(43) Pub. Date: Mar. 9, 2017

(54) Lens Carrier

(71) Applicants: Patrick C. Ho, Hilton, NY (US); Scott Leathersich, Henrietta, NY (US)

(72) Inventors: Patrick C. Ho, Hilton, NY (US); Scott Leathersich, Henrietta, NY (US)

(21) Appl. No.: 15/252,380

(22) Filed: Aug. 31, 2016

Related U.S. Application Data
(60) Provisional application No. 62/213,775, filed on Sep. 3, 2015.

(51) Int. Cl. G02C 5/02; G02C 13/00

(52) U.S. Cl. CPC G02C 5/02; G02C 13/001

(57) ABSTRACT

Disclosed is a lens carrier for a pair of lenses includes an eye-wire semi-embedded into a groove on the edge of each lens and locked to the carrier by hooks on each of the ends of eye-wires which are embedded into the lens edge and a bridge piece extending between and connecting the eye-wires, wherein the bridge piece has a mounting post which can be index mounted to a device so as to adjust the position of the lenses relative to the device.

### CROSS REFERENCE

This application claims the benefit of the filing date of U.S. Provisional Patent Application Ser. No. 62/213,775, filed Sep. 3, 2015, which is hereby incorporated by reference in its entirety.

### FIELD

The present invention relates to a lens carrier, and more particularly to a carrier for a pair of lenses each having a lens carrier eye-wire semi-embedded into a groove on the lens edge and secured by a hook on each end of the eye-wire.

### BACKGROUND

Smart glasses users who require some sort of visual correction need prescription lens inserts that mount easily to the smart glasses device.

Many smart glasses have electronic components, such as cameras and sensors, that would block standard lens shapes, so irregular lens shapes are required. Thus, these lenses require special lens carriers to secure the lenses to the smart glasses device.

Because irregular lens shapes cannot be held by standard frames or nylon wire, there is a need for a frameless and wireless lens carrier that uses lightweight material to secure prescription lenses.

### SUMMARY

In accordance with one aspect of the present invention, there is provided a lens carrier for a pair of lenses including a pair of eye-wires each capable of being semi-embedded into a groove on an edge of a respective pair of lenses and locked to the respective pair of lenses by hooks on each of the ends of eye-wires which are embedded into the lens edge; and a bridge piece extending between and connecting the pair of eye-wires, wherein the bridge piece has a mounting post which can be index mounted to a device so as to adjust the position of the lenses relative to the device.

In accordance with another aspect of the present invention, there is provided lens carrier in combination with and pair of lenses including a lens carrier having a pair of eye-wires each capable of being semi-embedded into a groove on an edge of a respective pair of lenses and locked to the respective pair of lenses by hooks on each of the ends of eye-wires which are embedded into holes in the lens edge and a bridge piece extending between and connecting the pair of eye-wires, wherein the bridge piece has a mounting post which can be index mounted to a device so as to adjust the position of the lenses relative to the device; and a pair of lenses, each having a groove on an edge of the lens, wherein the ends of the groove are provided with a hole for mating with the eye-wire hook.

In accordance with another aspect of the present invention, there is provided a method for mounting a lens to a lens carrier including snapping carrier hooks of a pair of eye-wires of a lens carrier in drill holes on the top and bottom of a groove on the edge of each lens; embedding the eye-wires into the groove on an edge of a respective pair of lenses; and snapping the bridge piece ends in a lens notch in the lens groove.

These and other aspects of the present invention will become apparent upon a review of the following detailed description and the claims appended thereto.

### BRIEF DESCRIPTION OF THE DRAWINGS

FIG. 1 is a front perspective view of a lens carrier secured to a pair of lenses in accordance with the present invention;

FIG. 2 is a rear perspective view of a lens carrier secured to a pair of lenses in accordance with the present invention;

FIG. 3 is a front view of a lens carrier secured to a pair of lenses in accordance with the present invention;

FIG. 4 is a rear view of a lens carrier secured to a pair of lenses in accordance with the present invention;

FIG. 5 is a side view of a lens carrier secured to a pair of lenses in accordance with the present invention;

FIG. 6 is a side view of a lens carrier secured to a pair of lenses in accordance with the present invention;

FIG. 7 is a bottom view of a lens carrier secured to a pair of lenses in accordance with the present invention;

FIG. 8 is a top view of a lens carrier secured to a pair of lenses in accordance with the present invention; and

FIG. 9 is a rear perspective view of a lens in accordance with the present invention.

### DETAILED DESCRIPTION

The present invention relates to a lens carrier for a pair of lenses, a pair of mounted lenses in combination with a lens carrier, and method for mounting a lens to a lens carrier. The disclosure includes a lens carrier having a pair of eye-wires. Each eye-wire has two ends and is semi-embedded into a groove on the edge of a respective lens. Each end of the eye wire has a hook wherein each hook is embedded into a respective hole on the lens edge that locks each end of the eye-wire to the lens. The eye-wire hook can be any shape and can be press fit into the hole disposed in the lens edge. The eye-wire typically has a round cross-sectional shape which can mate with a complementary cross-sectional shape of the lens groove. Any cross-sectional shape is suitable for use in the present disclosure. Each of the lenses is provided with an edge groove disposed adjacent the nose bridge section of the lens carrier for mating with the eye-wire. The eye-wire is semi-embedded in the lens groove which indicates that the eye-wire can be press fit into the groove. Thus, the eye-wire can be recessed, flush, or extend above the surface of the lens edge.

In an embodiment, the eye-wire semi-embedded in the lens stabilizes the lenses from rotating in the “z” axis and the hooks stabilize the lenses from rotating in the “x” axis. The present design enables a quick and simple assembly of the lenses to the lens carrier. Further stabilization is provided by a notch in the lens groove wall for mating with the bridge piece.

Each of the eye-wires of the lens carrier is connected to an end of a bridge piece that extends between a left and right eye-wire. The bridge piece has a mounting post which can be index mounted to a device so as to adjust the position of the lenses relative to the device, such as smart glasses.

To achieve the desired objects, a lens carrier is provided, and more particularly a carrier for a pair of lenses each having an eye-wire semi-embedded into a groove on the lens edge and secured by a hook on each end of the eye-wire.

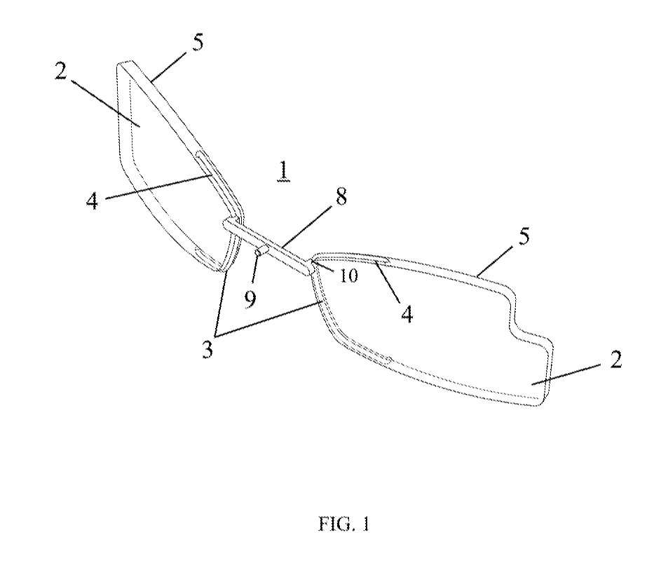

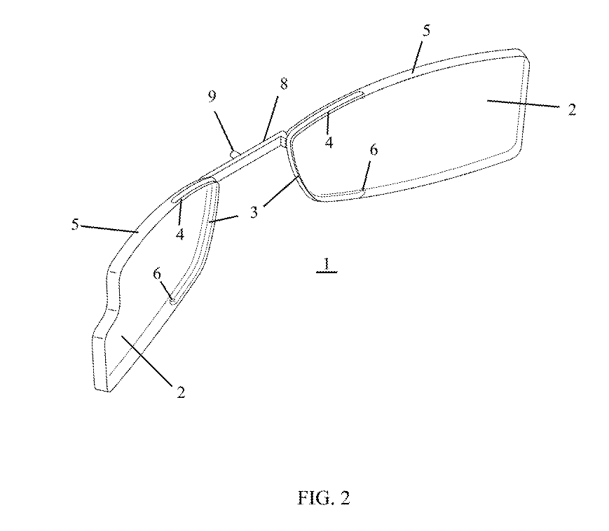

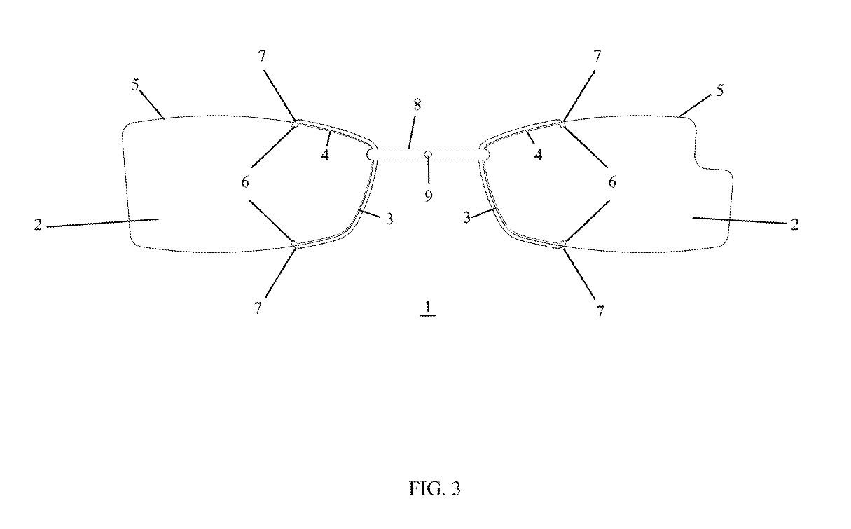

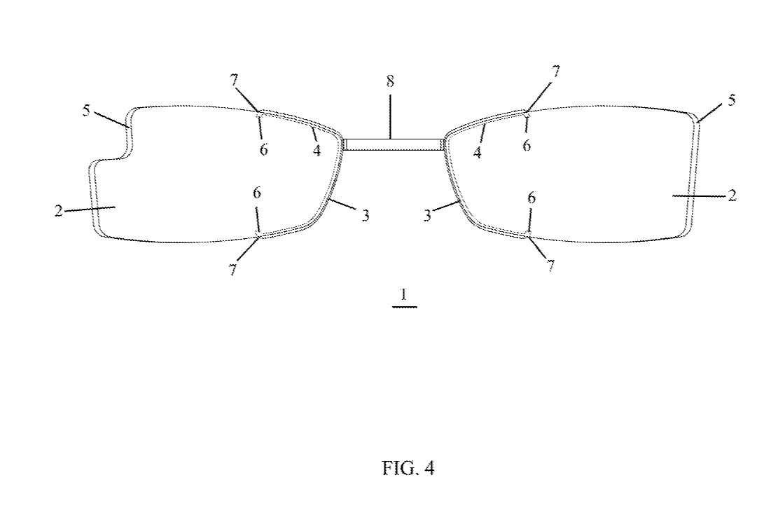

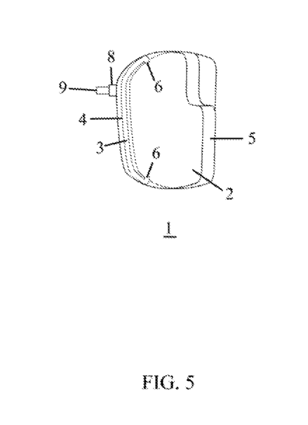

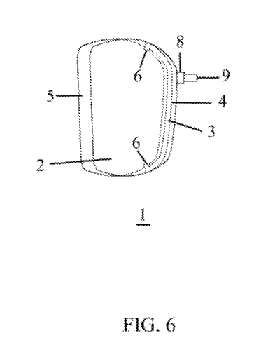

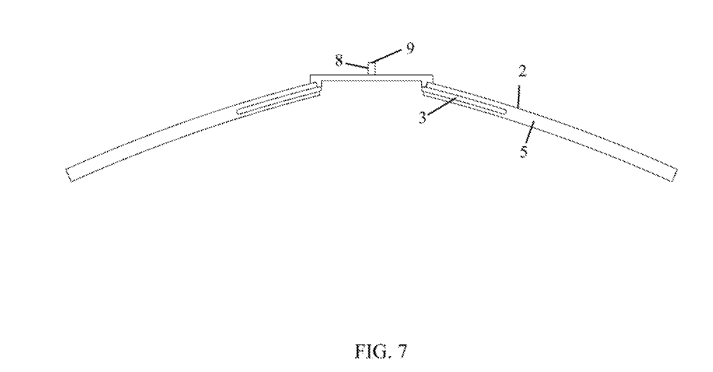

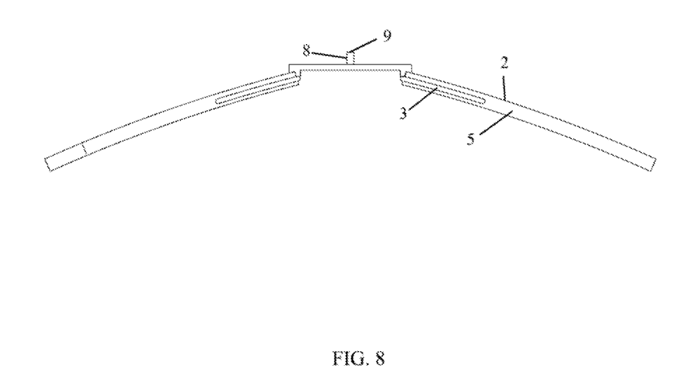

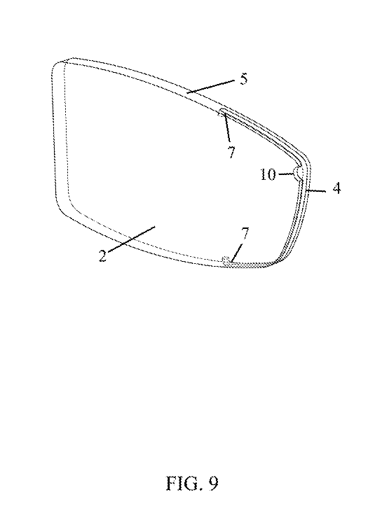

FIGS. 1-8 illustrate an embodiment of the lens carrier 1 for mounting a pair of lenses 2 which include an eye-wire 3 semi-embedded into a groove 4 along at least a portion of the lens edge 5 and locked by hooks 6 on the ends of eye-wires 3 on both sides which are embedded into a hole 7 in the lens edge 5. The eye-wire 3 semi-embedded in the lens edge 5 stabilizes the lenses 2 from rotating in the “z” axis and the hooks 6 stabilize the lenses 2 from rotating in the “x” axis. The eye-wires 3 are connected to a bridge piece 8 at each end thereof. The bridge piece 8 has a mounting post 9 which can be index mounted to a device (not shown) so as to adjust the position of the lenses 2 relative to the device. FIG. 9 illustrates a lens having a groove 4 along at least a portion of the lens edge 5 and a pair of holes 7 in the lens edge 5, one at each end of the groove capable of mounting to locking hooks on both ends of the eye-wires. A bridge piece notch 10 disposed on the back portion of the eye-wire groove 4 provides additional stabilization of the lens 2 to the carrier.

Disclosed is a lens carrier for a pair of lenses includes an eye-wire semi-embedded into a groove on the edge of each lens and locked to the carrier by hooks on each of the ends of eye-wires which are embedded into the lens edge and a bridge piece extending between and connecting the eye-wires, wherein the bridge piece has a mounting post which can be index mounted to a device so as to adjust the position of the lenses relative to the device. The bridge piece mates with a notch on the lens providing three index-point stabilization.

All lens carriers that do not have temple arms need screws or nylon wire to hold the lenses in place; but neither screws nor nylon wire work as a solution for smart glasses with electronic components that cannot be blocked. To accommodate unique smart glasses components, irregular lens shapes are required and often include sharp angles. Sharp angles create void areas that a traditional nylon wire or frame cannot wrap around, so this invention provides a nylon wire-less lens carrier solution for this special case.

No screws are needed to hold the lenses in place, so there is no minimum lens thickness required. This screw-less lens carrier system invention therefore allows lenses to be thinner than screw-dependent lens carrier systems.

Lenses can be easily mounted and dismounted by snapping the carrier hooks in and out of the drill holes on the top and bottom of each lens. The bridge piece mates with and can snap in the notch for the bridge piece. This mounting system allows lenses to be easily removed and replaced.

A frameless and nylon-wireless lens carrier is disclosed that uses lightweight material and drill mounts to secure prescription lenses. This invention will work with various irregular lens shapes, as drill-mount hooks rather than screws or nylon wire secures the lenses to the lens carrier.

The frame material used is minimal and lightweight as to easily integrate with smart glasses or fashion frames/eyeglasses both functionally and cosmetically.

A nosepiece can be added to the lens carrier to make it a pince-nez style, which is secured to the wearer's face by lightly pinching at the nose. The lens carrier is therefore usable as standalone eyeglasses in addition to functioning as an insert for smart glasses.

The lens carrier is also curved to provide additional stabilization without adding more material.

This invention will also work with any kind of fashion frames, it is not only related to smart glass devices, as prescription lenses can be easily removed and replaced.

Although various embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

What is claimed:

1. A lens carrier for a pair of lenses comprising:
a pair of eye-wires each capable of being semi-embedded into a groove on an edge of a respective pair of lenses and locked to the respective pair of lenses by hooks on each of the ends of eye-wires which are embedded into the lens edge; and
a bridge piece extending between and connecting the pair of eye-wires, wherein the bridge piece has a mounting post which can be index mounted to a device so as to adjust the position of the lenses relative to the device.

2. The lens carrier of claim 1, wherein the ends of the bridge piece are capable of mating to a notch in the groove on an edge of a respective pair of lenses.

3. A lens carrier in combination with and pair of lenses comprising:
a lens carrier comprising a pair of eye-wires each capable of being semi-embedded into a groove on an edge of a respective pair of lenses and locked to the respective pair of lenses by hooks on each of the ends of eye-wires which are embedded into holes in the lens edge and a bridge piece extending between and connecting the pair of eye-wires, wherein the bridge piece has a mounting post which can be index mounted to a device so as to adjust the position of the lenses relative to the device; and
a pair of lenses, each comprising a groove on an edge of the lens, wherein the ends of the groove are provided with a hole for mating with the eye-wire hook.

4. The lens carrier combination of claim 3, wherein the edge of each respective pair of lenses comprises a notch capable of mating with the ends of the bridge piece.

5. A method for mounting a lens to a lens carrier comprising:
snapping carrier hooks of a pair of eye-wires of a lens carrier in drill holes on the top and bottom of a groove on the edge of each lens;
embedding the eye-wires into the groove on an edge of a respective pair of lenses; and
snapping the bridge piece ends in a lens notch in the lens groove.
